(19) United States
(12) Patent Application Publication
(10) Pub. No.: US 2013/0199354 A1
(43) Pub. Date: Aug. 8, 2013

(54) HIGHLY FLEXIBLE PICK FOR STRINGED INSTRUMENTS

(71) Applicant: Frank Joseph Yavorski, Lithia, FL (US)

(72) Inventor: Frank Joseph Yavorski, Lithia, FL (US)

(21) Appl. No.: 13/369,266

(22) Filed: Feb. 8, 2012

(51) Int. Cl. G10D 3/16

(52) U.S. Cl. 84/322

(57) ABSTRACT

A highly flexible pick is used for playing stringed instruments. The pick will essentially be made of low-density polyethylene plastic to yield a pick that may reduce string breakage, be secure in a player's fingers, even during fast strumming, and may provide excellent tone from the stringed instrument. Because the pick is highly flexible, the pick may bend it is sounds the string, without the pick moving in the player's grip.

### BACKGROUND OF THE INVENTION

The present invention relates to music playing accessories and, more particularly, to a highly flexible pick for stringed instruments made from low density polyethylene (LDPE) plastic.

Picks for stringed instruments, such as guitars, come in various sizes and shapes. These picks are often rigid and may result in string breakage for new players. More experienced players may find these conventional picks hard to hold and control, especially during fast strumming.

Some design attempts made to solve the problem of the pick moving in the player's grip often resulted in complicated designs, such as varying the pick's thickness, putting holes in the pick, adding wings or bumps, or the like.

As can be seen, there is a need for an improved pick for stringed instruments.

### SUMMARY OF THE INVENTION

In one aspect of the present invention, a pick for playing a stringed instrument comprises a shaped piece of low density polyethylene adapted to be held in a player's grip between a player's thumb and finger; and a tip extended beyond the player's grip to strum over strings of the instrument.

In another aspect of the present invention, a method for playing a stringed instrument comprises holding a pick between a player's thumb and finger, with a tip of the pick extending there beyond, wherein the pick is made of low density polyethylene; and strumming the pick across one string of the stringed instrument, thereby sounding the string.

These and other features, aspects and advantages of the present invention will become better understood with reference to the following drawings, description and claims.

### BRIEF DESCRIPTION OF THE DRAWINGS

FIG. 1 is a perspective view of a pick, in use, according to an exemplary embodiment of the present invention;

FIG. 2 is a perspective view of the pick of FIG. 1;

FIG. 3 is a front view of the pick of FIG. 1;

FIG. 4 is a cross-sectional view taken along line 4-4 of FIG. 1;

FIG. 5 is a perspective view of a pick according to another exemplary embodiment of the present invention; and

FIG. 6 is a front view of the pick of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a highly flexible pick for playing stringed instruments. The pick is essentially made of low-density polyethylene plastic to yield a pick that may reduce string breakage, be secure in a player's grip, even during fast strumming, and may provide excellent tone from the stringed instrument. Because the pick is highly flexible, the pick will bend it is sounds the string, without the pick moving in the player's grip.

As used herein, the term “highly” as it modifies “flexible”, describes a feature of a pick where the tip of the pick may flex without disturbing the user's grip of the pick between their thumb and finger. A pick that is not highly flexible may cause the entire pick to angle while strumming across strings.

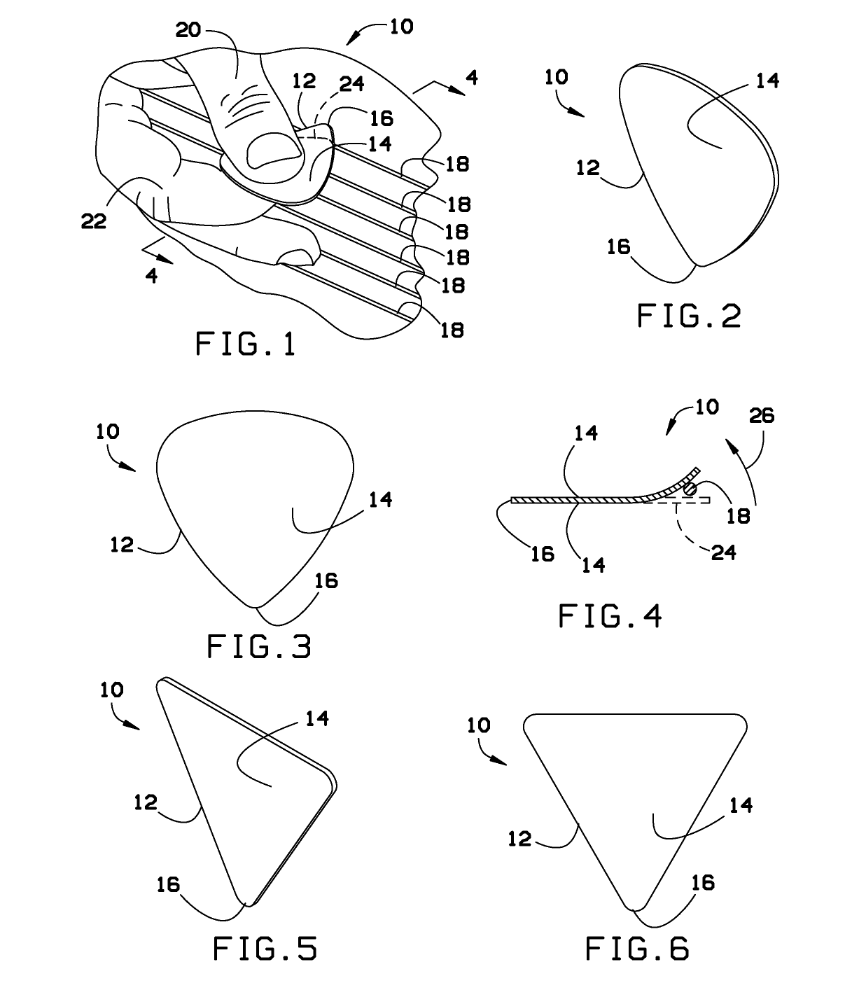

Referring to FIGS. 1 through 4, an instrument having strings 18 may be played by a pick 12. A user may hold the pick 12 between their thumb 20 and their fore-finger 22 and sound the strings 18 by strumming a tip 16 of the pick 12 there along. The pick 12 may flex (shown generally by arrow 26) away from its no-flex position 24 as shown in FIGS. 1 and 4. The highly flexible nature of the pick 12 allows it to flex without angling in the user's grip (in other words, a gripping surface 14 may remain flat as the pick is angled during strumming of strings, for example), thereby making the pick 12 easy to retain in the user's grip, even during fast strumming.

As shown in FIGS. 5 and 6, the pick 12 may be designed in various shapes. For example, the pick may be formed in a teardrop shape (as shown in FIGS. 1 through 4), or in a triangular shape.

The pick 12 will be made of low-density polyethylene (LDPE)which has inherent properties that makes it an ideal choice for making a highly flexible pick. For example, LDPE is chemically inert, slippery, durable and sheds moisture. The pick's flexibility may be adjusted by varying the thickness of the pick. Typically, the LDPE pick may have a thickness between about 0.4 mm to about 1.5 mm.

The picks of the present invention may be made from various processes. For example, the picks may be made from cutting and punching different shapes from sheets of LDPE. In some embodiments, the picks may be made through an injection molding process. Regardless of the method of manufacture, the picks of the present invention may be made of a uniform material throughout the pick, thereby resulting in a relative ease of manufacture as compared to some conventional picks that may be made of multiple materials. The material of the picks of the present invention may further be made of a uniform thickness.

The picks of the present invention are flexible, durable and slippery against the strings. The picks are easy to use, allowing the artist to focus on the music rather than their grip on the pick. The picks of the present invention may result in improved tone and may be capable of sounding the strings without the metal string versus pick sound that may typically occur with nylon or hard plastic picks.

It should be understood, of course, that the foregoing relates to exemplary embodiments of the invention and that modifications may be made without departing from the spirit and scope of the invention as set forth in the following claims.

What is claimed is:

1. A pick for playing a stringed instrument, comprising:
a shaped piece of low density polyethylene adapted to be held in a player's grip between a player's thumb and finger; with
a tip extending beyond the player's grip to strum over strings of the stringed instrument.

2. The pick of claim 1, wherein the low density polyethylene is shaped as a teardrop.

3. The pick of claim 1, wherein the low density polyethylene is shaped as a triangle.

4. The pick of claim 1, wherein the stringed instrument is a guitar.

5. The pick of claim 1, wherein the entire pick is made of low density polyethylene having a uniform thickness.

6. A method for playing a stringed instrument, comprising:
holding a pick between a player's thumb and finger, with a tip of the pick extending there beyond, wherein the pick is made of low density polyethylene; and
strumming the pick across a string of the stringed instrument, thereby sounding the string.

7. The method of claim 7, further comprising flexing the pick to a flexed position while the pick is strumming the string, wherein the flexed position does not disturb the pick's orientation being held between the player's thumb and finger.

8. The method of claim 7, wherein the stringed instrument is a guitar.

9. The method of claim 7, wherein the pick is made of low density polyethylene having a uniform thickness.
